(19) United States
(12) Patent Application Publication
(10) Pub. No.: US 2021/0203711 A1
(43) Pub. Date: Jul. 1, 2021

(54) Embedded Mobile Browser

(71) Applicant: Button, Inc., New York, NY (US)

(72) Inventors: Christopher James Maddern, New York, NY (US); Wesley Duncan Smith, Windham, ME (US); Paul Alan Fleiner, Brooklyn, NY (US)

(73) Assignee: Button, Inc., New York, NY (US)

(21) Appl. No.: 16/918,380

(22) Filed: Jul. 1, 2020

Related U.S. Application Data
(60) Provisional application No. 62/955,553, filed on Dec. 31, 2019.

(51) Int. Cl. H04L 29/08; G06F 16/955; G06F 9/451; G06F 16/957; G06F 16/9535; G06N 20/00

(52) U.S. Cl. CPC H04L 67/02; G06F 16/9566; G06N 20/00; G06F 16/9577; G06F 16/9535; G06F 9/451

(57) ABSTRACT

The technology is directed to a web browser and associated systems and methods for providing tailored experiences based on a user's use of the web browser. One or more processors may receive a requested URL and classify the requested URL into an activity type. The one or more processors may retrieve additional information associated with the requested URL based on the classified activity type and determine one or more driving actions based on the activity type and the retrieve additional information, each of the one or more driving actions configured to cause a web browser to perform an action. The one or more processors may provide the one or more driving actions, the classified activity type, and the additional information to the web browser.

### CROSS-REFERENCE TO RELATED APPLICATION

This application claims the benefit of the filing date of U.S. Provisional Patent Application No. 62/955,553 filed Dec. 31, 2019, the disclosure of which is hereby incorporated herein by reference.

A web browser is typically programmed to retrieve content from web servers, and present it to users in an interactive fashion. Typically, web browsers are configured to handle a range of formats, standards, scripts, cookies, and other such technology commonly used to implement websites and other such content. As the nature of the content that a web browser displays may vary between different websites and other such locations, most web browsers are programmed to handle the most common technologies to assure support for the largest amount of content, without tailoring them to particular content and without requiring websites and other content to be in compliance with particular standards designated by the web browser. As such, the vast majority of browsers have the same features that are built for “general” use-cases such as email, reading news, browsing or posting to social networks.

### BRIEF SUMMARY

Embodiments within the disclosure relate to supplementing information received from a uniform resource locator (URL). In one aspect of the disclosure a method for supplementing information includes receiving, by one or more processors, a requested URL; classifying, by the one or more processors, the requested URL into an activity type; retrieving, by the one or more processors, additional information associated with the requested URL based on the classified activity type; determining, by the one or more computers, one or more driving actions based on the activity type and the retrieve additional information, each of the one or more driving actions configured to cause a web browser to perform an action; and providing, by the one or more processors, the one or more driving actions, the classified activity type, and the additional information to the web browser.

In one example, a requested URL is received from the web browser.

In some instances classifying the requested URL into an activity type includes determining a type of activity that occurs on the webpage associated with the requested URL. In some instances, determining a type of activity that occurs on the webpage includes inputting the requested URL into a machine learning model, the machine learning model configured to output the classified activity type.

In some instances, the additional information includes user data associated with a user of the browser; product reviews for a product on a webpage of the requested URL, confirmation that a checkout was completed based on the context of the webpage of the requested URL, an indication that the webpage of the requested URL is a checkout page; an indication that a product was added to a cart of an online retailer associated with the requested URL, and/or information that a product is on the requested URL.

In some instances, determining the one or more driving actions further includes: selecting one or more predefined driving actions based on context including user data and the classified activity type; ranking the selected predefined driving actions; and selecting one or more of the highest ranked predefined driving actions as the one or more driving actions to provide to the web browser.

In some instances, the method includes providing a token to the web browser, the token identifying a user or user account of the web browser.

Another aspect of the disclosure is directed to a system for supplementing information received from a uniform resource locator (URL). The system includes one or more processors; and one or more storage devices in communication with the one or more processors, wherein the one or more storage devices contain instructions configured to cause the one or more processors to: receive a requested URL; classify the requested URL into an activity type; retrieve additional information associated with the requested URL based on the classified activity type; determine one or more driving actions based on the activity type and the retrieve additional information, each of the one or more driving actions configured to cause a web browser to perform an action; and provide the one or more driving actions, the classified activity type, and the additional information to the web browser.

Another aspect of the disclosure is directed to a non-transitory computer readable medium containing instructions, which when executed by one or more processors, cause the one or more processors to: receive a requested URL; classify the requested URL into an activity type; retrieve additional information associated with the requested URL based on the classified activity type; determine one or more driving actions based on the activity type and the retrieve additional information, each of the one or more driving actions configured to cause a web browser to perform an action; and provide the one or more driving actions, the classified activity type, and the additional information to the web browser.

### BRIEF DESCRIPTION OF THE DRAWINGS

FIG. 1 is an example distributed computing system 100 in accordance with embodiments of the disclosure.

FIG. 2 is an example illustration of operations performed by components of system 100 when launching a browser and loading a page, in accordance with aspects of the disclosure.

FIG. 3 is a flow diagram representing the classification of an activity type of a URL according to aspects of the disclosure.

FIG. 4 is an example illustration of operations performed by components of system 100 while a web page is loaded in accordance with aspects of the disclosure.

FIG. 5 is a flow diagram representing the classification of an activity type of an activity in accordance with aspects of the disclosure.

FIG. 6 is an example illustration of an extension according to aspects of the disclosure.

FIG. 7 shows example cards according to aspects of the disclosure.

### DETAILED DESCRIPTION

### Overview

The present disclosure is directed to providing enhanced shopping features that work with a large range of content. These features may include enriching data, driving actions, and automating commissions on purchases, as described in greater detail herein. The features can be implemented in a customized web browser offered by a service to a publisher. The publisher may embed the customized web browser into applications, such a mobile apps. The publisher applications may be made available for use by a user base. During use of the publisher's application, the customized web browser may be provided in place of another browser, such as the system's native browser or other such browser (e.g., Chrome, Safari, or other third party browsers like Firefox, Brave etc.). The customized web browser may include a developer interface through which features may be added, removed, or otherwise adjusted to further customize the customized web browser by the publisher. Although the features described herein are discussed with regard to a customized web browser, the features may also be implemented in one or more web browser extensions to improve the capabilities of a general purpose web browser. In some instances, the customized web browser may be a standalone web browser not embedded within a publisher application.

Shopping activity may be generally defined as any action one may take when shopping online. A typical online shopping experience can generally be broken into a few stages of activity including searching for a product, viewing a product, adding a product to a cart, viewing a cart, initiating checkout, making a purchase, and other such activities or variations thereof. In order to provide enhanced shopping features, user web activity may be monitored and relevant data collected to determine when the user is engaged in one or more of the shopping stages and, in some instances, which shopping stage or stages the user is engaged. Depending on the shopping stage the user is engaged, enhanced shopping features for that shopping stage may be provided.

The systems and methods described herein provide for a commerce focused web browser capable of providing a richer, more engaging shopping experience for a user. Additionally, the technology described herein results in better conversion rates and provides enhanced intelligence and data capabilities to the publisher that has embedded the customized web browser into their application.

### Example Systems

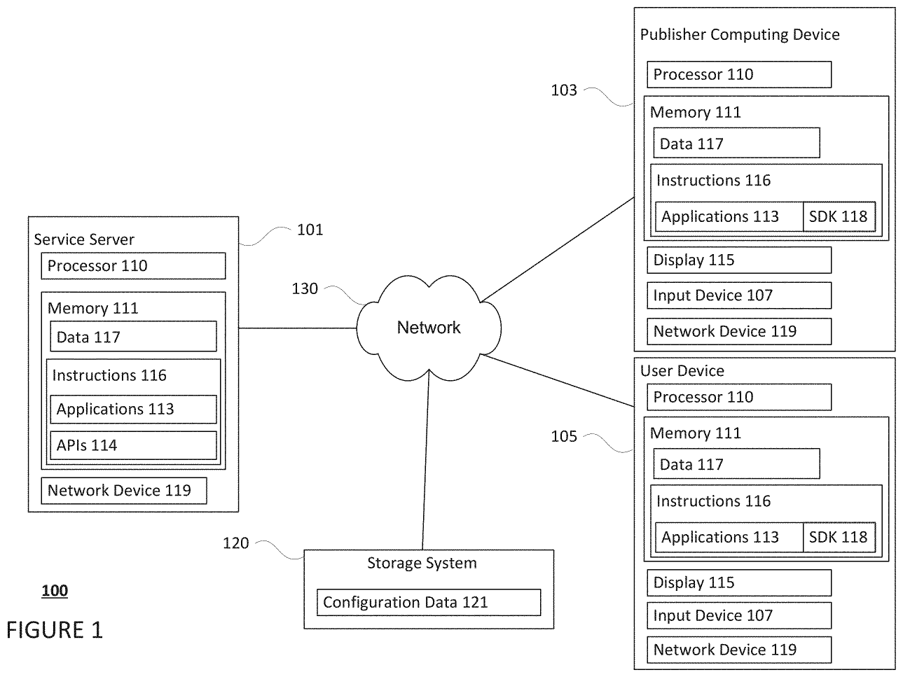

FIG. 1 shows an example distributed computing system 100 in which the features described herein may be implemented. In this example, system 100 includes service server 101, publisher computing device 103, and user device 105, which may each be referred to as computing devices. The distributed computing system 100 may also include one or more storage devices, such as storage system 120. Communication between the computing devices 101-105, as well as between the computing devices 101-105 and storage device 120 and other devices, may be performed via network devices 119 through network 130, as described herein. Although not shown, communication between components of each computing device may be made through one or more communication buses. For instance, the processor 110, memory 111, and network device 119 of publisher computing device 103 may communicate via a communication bus.

FIG. 1 should not be considered as limiting the scope of the disclosure or usefulness of the features described herein. In this regard, the features described herein may be implemented with many types of general or special purpose computing devices, such as personal computers, laptops, tablets, mobile phones, virtual computers, etc. Further, the features described herein may be implemented using many different combinations of devices. Moreover, although only computing devices 101-105 are depicted in FIG. 1, it should be appreciated that a typical system can include a large number of connected computing devices, such as more than one service server, publisher computing device, and/or user device.

Each computing device 101-105 may contain one or more processors 110, one or more memory 111, and/or other components commonly found in general and special purpose computing devices. For example, service server 101 includes one or more processors 110, memory 111, and network interface 119. Other service servers (not shown) may include some or all of the components shown in service server 101.

The one or more processors 110 can be any conventional processors, such as commercially available CPUs from Intel®, AMD®, or Apple®. Alternatively, or in addition to the commercially available CPUs, the processors can be dedicated components such as an application specific integrated circuit (“ASIC”) or other hardware-based processors, such as an ARM processor, field programmable gate array (FPGA), or System on Chip (SoC).

Memory 111 may store information that can be retrieved, executed, and/or manipulated by the processors 110, such as instructions 116 and data 117. The memory 111 may be any type of non-transitory computer readable media that is readable and/or writable by the computing devices 101-105. For instance, computer readable media may include volatile and/or nonvolatile disk based hard drives, solid state hard drives, hybrid hard drives, memory cards, flash read-only memory (ROM), random access memory (RAM), NAND memory, DVDs, CD-ROMs, EEPROM, and other magnetic or optical storage. The memory 111 can include any combination of non-transitory computer readable media, such as a hard drive and RAM, etc.

The instructions 116 may be stored in any format which may be read and executed by the processor. In this regard, the instructions may include any executable code, such as machine code, scripts, applications, such as applications 113, etc. Applications 113 may include, for instance, an operating system (OS), a web browser described herein, web browser extensions, mobile applications, computer applications, etc. In some instances, instructions 116 may include portions of executable code, such as application modules which are part of a larger application, or entire applications, such as one or more of applications 113.

The instructions 116 may also include APIs 114, SDKs 118, as described herein. For instance and as further illustrated in FIG. 1, instructions 116 of service server 101 may include one or more APIs 114, such as the API's discussed herein. As further illustrated in FIG. 1, instructions 116 of publisher computing device 103 and user device 105 may include one or more SDKs 118, which may enable communication with API 114 of service server 101. The SDKs 118 may also provide developers with programming tools to create or otherwise customize applications, such as customized web browsers or extensions, as described herein. Although SDK 118 is shown as being within application 113, SDK 118 may be a standalone application. Likewise APIs 114 may be part of applications 113.

The instructions 116 may include models, rules, etc., that may be used in providing the features described herein. A model may include an activity model that may determine whether the URL(s) being visited within a browser or activity occurring in a browser is indicative of a user engaging in one or more shopping stages. In some instances, separate models may be used for determining whether the URL(s) being visited within a browser are indicative of one or more shopping stages and whether activity occurring in a browser is indicative of a user engaging in one or more shopping stages. Another model may include a personalization model configured to provide personalized recommendations, suggestions, advertisements, deals, etc., to a user based on user data. The models may be machine learning models which may be trained using user data. Rules may be used in place of or in conjunction with models. For example, rules may be configured to determine which recommendations to provide and/or determine which activity type a requested URL(s) corresponds or whether activity within a webpage is indicative of an activity type. Moreover, the rules may define which databases or other such sources of information may be accessed to determine gather enrichments to supplement other data. The rules may be static such that they are not altered absent being reprogrammed. In some instances the rules may be dynamic such that they may be automatically adjusted or adjusted periodically.

Data 117 may be retrieved, stored, or modified by the one or more processors 110 based on instructions 116. For example, although the system and methods described herein is not limited by any particular data structure, the data 117 can be stored in registers, databases, such as relational databases, tables, or XML documents. The data 117 is not limited to any particular data structure or format. For instance, the data 117 can include individual pieces or data as well as larger data structures such as relational databases, tables, XML documents, etc. Additionally, the data may be formatted in many formats such as, but not limited to, binary values, ASCII or Unicode. Moreover, the data 118 can include any information sufficient to identify and/or differentiate relevant information, such as numbers, descriptive text, proprietary codes, pointers, references to data stored in other memories, such as at other network locations, or information that is used by a function to calculate the relevant data.

The data 117 may include user data and other such data that may be used in providing the features described herein. User data may include, by way of non-limiting examples, historical data such as past user shopping history such as past purchases and past product viewing, past user browsing history, user preferences, user profile data (e.g., names, age, sex, address, phone number, etc.,) and other such data. Data 117 may also include product data.

Storage system 120 can include any type of storage capable of storing information accessible by the service server 101, publisher computing device 103, and/or user device 105. As shown in FIG. 1, storage system 120 may store configuration data 121. Configuration data 121 may include data used to convert a received URL into a customized URL, such that the URL is directed to the service server 201. In some instances, configuration data may be stored in memory 111 of service server 101 and/or publisher computing device 103. Storage system 120 may also store any of the other data or instructions described herein, including user history data, models, rules, etc.

Storage device 120 may include a distributed storage system where data is stored on a plurality of different storage devices which may be physically located at the same or different geographic locations, such as network attached storage or distributed data warehouses. Storage device 150 may be connected to the computing devices via the network 130 as shown in FIG. 1, and/or may be directly connected to any of the computing devices 101-105. Although only a single storage system 120 is shown in FIG. 1, any number of storage systems may be included in the example distributed computing system 100. In some instances, access to storage system 120 may be limited to particular computing devices. By way of a non-limiting example, storage system 120 may be configured to communicate with user device 105 and service server 101, but not publisher computing device 103. In some instances, a storage system may be provided for each computing device or groups of computing devices.

Each of the computing devices 101-105 can be at different locations of a network 130 and capable of directly and indirectly communicating with other components at different locations on the network 130. Although only computing devices 101-105 are depicted in FIG. 1, it should be appreciated that a typical system can include a large number of connected computing devices, with the different computing devices being at the same and/or different locations on the network 130. The network 130 described herein can be interconnected using various protocols and systems, such that the network can be part of the Internet, World Wide Web, specific intranets, wide area networks, or local networks. The network can utilize standard communications protocols and technologies, such as by way of non-limiting examples, Ethernet, Wi-Fi, HTTP, 3G, 4G, 5G, Bluetooth, and UDP protocols that are proprietary to one or more companies, and various combinations of the foregoing. Although certain advantages may be obtained when information is transmitted or received as noted above, other aspects of the subject matter described herein are not limited to any particular manner of transmission of information.

The computing device 101-105 may each have a network device 119 for enabling communication with other computing devices or networked systems. For instance, network device 119 may include a network interface card (NIC), Wi-Fi card, Bluetooth receiver/transmitter, or other such device capable of communicating data over a network via one or more communication protocols and technologies. As an example, service server 101 may be a web server capable of communicating with storage system 120 as well as computing devices 103 and 105 through the network 130 via network devices 119. The web server of service server 101 may use network 130 to transmit and present information to a user, such as on a display 115 of user device 105.

Each of the computing devices 103 and 105 may be configured similarly to the service servers 110, with one or more processors, memory, and storage mediums as described above. Computing devices 120 and 130 may be a personal computing device intended for use by a user, and have all of the components normally used in connection with a personal computing device such as a central processing unit (CPU), memory (e.g., RAM and internal hard drives) storing data and instructions, a display such as display 115, (e.g., a monitor having a screen, a touch-screen, a projector, a television, or other device that is operable to display information), and input device 107 (e.g., a mouse, keyboard, touch-screen, or microphone). Although not shown, service server 101 may also include displays and user input devices.

Although the computing devices 103 and 105 may each comprise a full-sized personal computing device, they may alternatively comprise mobile computing devices capable of wirelessly exchanging data with a server, such as service server 101 over a network such as the Internet. By way of example only, user device 105 may be a mobile phone or a device such as a wireless-enabled PDA, a tablet PC, or a netbook. In another example, user device 105 may be a laptop computer.

Although FIG. 1 illustrates the processor 110, memory 111, storage medium 112, and other elements of computing devices 101-105 as being within the same device, the processor 110, memory 111, storage medium 112, and other elements of computing devices 101-105 may be stored in different locations or housings. For example, and referring to service server 101, the processor 110, and memory 111 may be located in a different housing from storage medium 112. Accordingly, references to a processor, computer, computing device, memory, or storage medium will be understood to include references to a collection of processors, computers, computing devices, memories, or storage mediums that may or may not operate in parallel. For example, the service server 101 may include server computing devices. The service server 101 may be configured to operate as a load-balanced server farm, distributed system, etc. Similarly, publisher computing device may be configured as a server. Yet further, although some functions described below are indicated as taking place on a single computing device having a single processor, various aspects of the subject matter described herein can be implemented by a plurality of computing devices that, for example, communicate information over network 130.

### Example Methods

In addition to the operations and systems described above and illustrated in the figures, various operations will now be described. The following operations do not have to be performed in the precise order described below. Rather, various steps can be handled in a different order or simultaneously, and steps may also be added or omitted.

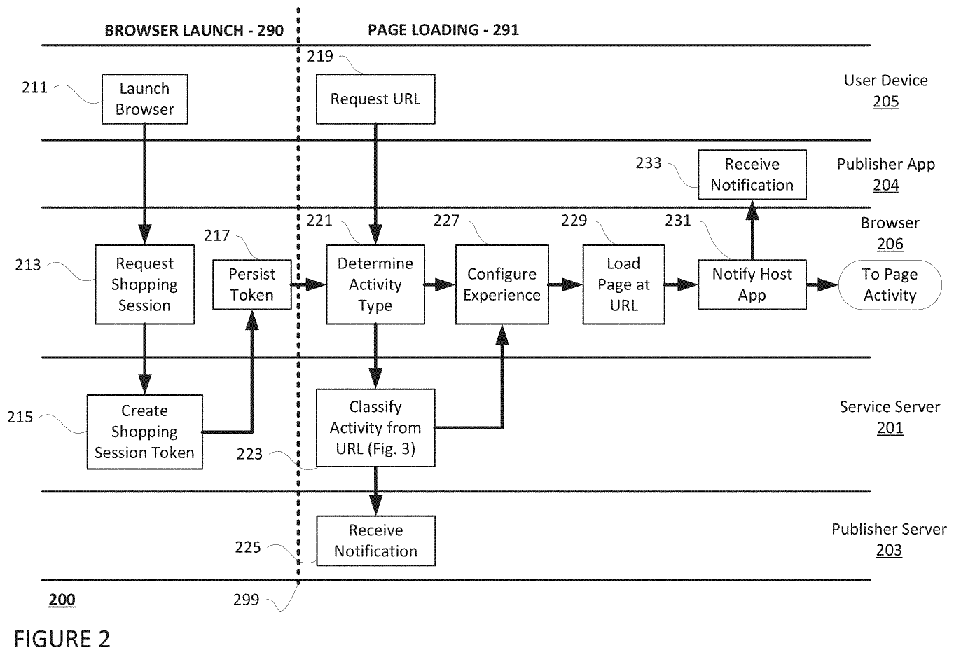

FIG. 2 illustrates a flow diagram 200 outlining the general operation of a system for providing enhanced shopping features. As shown in FIG. 2, the components of the system may include a user device 205, which may be similar to user device 105, a server 201, which may be similar to service server 101, and publisher server 203, which may be similar to publisher computing device 103. A customized browser 206 may be embedded in publisher app 204 published by the publisher and installed on the user device 205. Although the examples and features described herein are described as being performed or otherwise implemented on the customized browser 206 that is embedded within publisher app 204, the customized browser 206 may be a standalone browser not embedded within the customized browser 206. Additionally, the features and examples described herein may be implemented via one or more browser extensions.

In general, the operation of the system may be considered in three parts—(1) launching of the customized browser, (2) loading pages within the customized browser, and (3) conducting activity within a page on the browser. FIG. 2 illustrates the first two parts, with the operation of the system during the first part of launching of the customized browser being shown in section 290 to the left of the dashed vertical line labeled 299. The second part showing the operation of the system during page loading is shown in section 291 to the right of the dashed vertical line 299. Part three is discussed with reference to other figures herein.

Referring to the first part, launching of the customized browser 290, the customized web browser 206 on the user device 205 may be launched, as shown in block 211. The customized web browser 206 may be launched when the publisher app 204 is opened by a user and/or upon another action being performed in the publisher app 204 causing the customized web browser 206 to launch.

After being launched, the web browser 206 may request a shopping session from the service server 201 via a network, such as network 130, as shown in block 213. The service server 201 may create a shopping session token, as shown in block 215, and forward the token to the browser 206. The token may persist in browser 206 while the browser is in use on the user device 205, indefinitely, or for some predefined range of time, as shown in block 217. The token may be an opaque string that is well-known to the service and represents the user account, at retailers (e.g., shopping websites,) with a set of commission rules that were in effect at the time the shopping session began. In this regard, the token may provide a traceable communication pathway between the service server 201 and browser 206.

The token may be saved on the service server 201, where it may be tied to the user account, retailers, publishers, and other data. The token may also be saved in the customized browser and/or user device. In this regard, the customized browser 206 may store the token natively in the browser code and/or in other formats/locations, such as Javascript or other such scripts, in a cookie, and/or within local storage inside of the webpage within the browser. The token may be provided in all communications between the service server 201 and the customized browser 206 so that all activity, such as page loads with in the customized browser, URL and activity classification requests, classification returns, etc., tie back to the user and the commission rules that apply for the user.

Over the communication pathway the browser 206 may forward data to the service server 201, such as URLs visited by the browser, content sent to and/or from by the browser, actions taken by a user within the browser, information about the user or user device, the retailer of the webpage being viewed, the publisher app if the customized browser is embedded within a publisher app, etc. The service server 201 may also provide data to the browser 206, such as driving actions, as described herein, over the communication pathway.

The information provided from the browser 206 to the service server 201 may be stored in association with a user account. For example, a user account may correspond to a device, such that all information provided from the browser 206 to the service server 201 regardless of the user is stored in a single user account assigned to the particular device. In another example, a user account may correspond to a single user or collection of users. In this regard, a user of the browser 206 and/or publisher app 204 may login to an account. Identification information associated with the logged-in account may be forwarded to the service server 201, which may then store information provided from the browser 206 in association with the account identified by the identification information.

Referring to the second part, loading pages within the customized browser 291, a request for a particular URL may be made by the user device 205, as shown in block 219. Although the request for a URL is shown as being made by the user device 205 and being sent to the browser 206, the browser 206 may automatically request a URL such as when being launched. Moreover, although the operation of the second part of the system is shown a loading requests for URLs, request for web pages or other web content may made by entering other location identifiers, such as IP addresses.

For each requested URL, the customized browser 206 may forward the requested URL to the service server 201 with a request to determine an activity type associated with the requested URL, as shown in block 221. For each requested URL received from the customized browser 206, the service server 201 may determine if the requested URL is indicative of an activity type, as shown in block 221. That is to say, the service server 201 may receive the requested URL from the customized browser 206 and determine whether the requested URL can be classified as an activity type, and if so, which activity type. Activity types, which may also be called shopping activity stages, may include searching for a product, viewing a product, adding a product to a cart, viewing a cart, initiating checkout, making a purchase, and other such activities associated with shopping, as well as variations and combinations thereof.

The service server 201 may use static rules, trained data models, or other such techniques to determine whether the requested URL can be classified as an activity type based on components of the requested URL, the contents of the page associated with the requested URL which may be retrieved by the service server 201 or provided by browser 206, or other such data. Activity models may be trained using training data associated with observed user shopping sessions. For instance, user shopping sessions may be tracked and each web page or progression of web pages may be manually tagged with an activity type as observed while the user was on the respective web page or progression of web pages. This data, including some or all of the URLs associated with the webpages and the corresponding tags may be used as training data to generate an activity model to automatically classify URLs or progressions of URLs received from the customized web browser 206. Incoming URLs or progressions of URLs may then be classified using the trained activity model resulting in the URL being (or not being) classified into an activity type.

Similarly, activity models can be trained on aggregated data. For instance, a model may be trained using orders and all page views that were seen in those sessions that resulted in orders. Using this data, the trained activity model can predict the likelihood of a page being a checkout confirmation page.

With regard to static rules, there may be regex patterns (with capture group) that may provide identification of a page type (e.g. a product page “∧walmart.com∨product∨(.*)”) where the capture group expresses the ID of the product for lookup in a product database owned by the service. Based on the page type, an activity type may be determined. For instance, a particular page type may be associated with a particular activity type.

In the event the service server 201 determines that the requested URL may be classified as an activity type, the service server 201 may provide enhanced shopping features, such as data enrichment and driving actions based on the classified activity type, as further described herein.

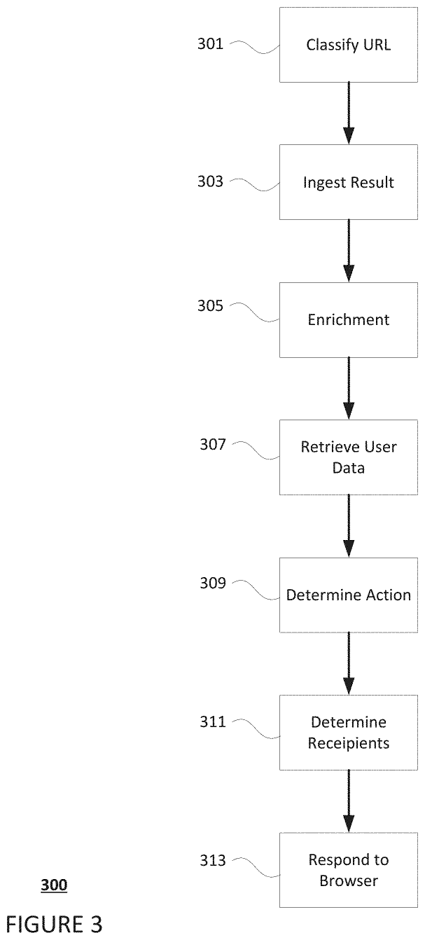

FIG. 3 shows a flow diagram 300 of steps the service server 201 may undertake when a requested URL is received from the customized browser 206. As shown in block 301, and as previously described, after receiving the requested URL the service server 201 may classify the requested URL as an activity type. In the event the service server 201 determines that the requested URL may not be classified as an activity type, the service server 201 may cease further processing and wait for the next requested URL to be received from the customized browser 206.

During or after classification of the requested URL, the results may be ingested by the service server 201, as shown in block 303. For example, the requested URL and activity type classification of the requested URL may be stored with the user data. In some instances, the results may be input into the user personalization model. In this regard, the user personalization model may be retrained with requested URL and activity type classification to further refine the personalization model associated with the user data.

As shown in block 305, the service server 201 may enrich the data associated with the requested URL with additional data. In this regard, based on the determined classified activity type the service server 201 may gather additional information from additional data sources. The additional data sources may be kept by the service, provided from sources partnered with the service (e.g., publishers, retailers, etc.,) and/or provided from other sources which the service has access.

For example, the requested URL may be classified as an activity type “Viewing a Product,” but the product on the webpage associated with the requested URL may not be available from the requested URL. Rather, in the given example, the product may be identified by an arbitrary identifier, such as “product 1234”, assigned by the retailer associated with the requested URL. The service may have a partnership with the retailer, which may include access to the retailer's database of products. Based on the activity type “Viewing a Product,” and a determination that the requested URL belongs or otherwise corresponds to the retailer, the service server may retrieve information corresponding to “product 1234” from the retailer's database of products. This additional information regarding “product 1234” may include information identifying the product, such as the type of product, brand of the product, etc. For instance, information retrieved from the retailer's database may indicate “product 1234” corresponds to a brand name 32″ television. The service server 201 may also determine the product being viewed is in the category of TVs, as well as other metadata associated with the product, such as a price of the TV, size of the TV, brand of the TV, etc.

Although the foregoing example describes a situation where the service has a partnership with the retailer that allows for the service server 201 to access the retailers database, the service server 201 may acquire additional information from other sources. For instance, the service server 201 may access a universal product code (UPC) database to match UPCs in the requested URL to a product. In another example, the service server 201 may access databases of other parties through public APIs. In yet another example, the service server 201 may scrape the webpage associated with the requested URL and use structured data analysis, natural language processing, JSON tags, or other such processes and data, to determine additional information. For example, the requested URL may be classified as an activity type “Viewing a Product.” To determine additional information about the product being viewed, the service server 201 may access the webpage associated with the requested URL and gather meta tags from the page. Based on these meta tags, additional information about the product on the webpage may be determined.

Additional data that may be used to enrich the data associated with the requested URL (or activity as described herein) may include product reviews for a product being viewed, search results for a product or similar products on a retailer's website, search results for a product, similar products, and/or a retailer from a search engine, confirmation that a checkout was completed based on the context of the currently viewed webpage; information indicating that a user is on a checkout page, information that a user added a product to a cart, information that a user is viewing a product, etc.

Some or all of the additional data gathered by the service server 201 may be used to enrich the data associated with the requested URL. This enriched data may be stored with and/or in association with user data. Moreover, the enriched data may be used to further refine and/or train the personalization model associated with the user. The personalization model may be used to tailor driving actions for a user based on historical data associated with the user. For instance, the personalization model may be used to determine whether the user has seen an offer, rebate, product, or other such driving action before, and based on the past user action adjust the driving action provided to the user or show the same driving action. Moreover, the personalization may allow for the customization of driving actions presented to a user based on past activity, shopper value, retailer targeting etc., as described herein.

As shown in block 307, user data may be retrieved by the service server 201. User data may include any information associated with the user data of the user that requested the requested URL. Based on the retrieved user data, as well as other data driving actions may be selected by the service server 201, as shown in block 309. Driving actions may include any commerce feature that may cause or otherwise influence a user's purchase of a product. In one example, driving actions may include product recommendations based on the current product being viewed and the user's past purchases. Other example driving actions include a notification that the same product being viewed on the requested URL is available at another retailer for a cheaper price, a notification that a bonus or offer is available for the product on the webpage associated with the requested URL or for a competing product, a notification that a higher end (or lower end) product may be more to the user's liking, etc.

Driving action may be selected based on many factors, including, but not limited to context and expected value. Context may be defined as what makes sense given the known details, such as the user, URL being visited, etc. For instance, if the user's viewing a product, a price comparison, reward, or alternative product recommendation may be made. In another example, if a user added a product to their cart, a bundling product recommendation, or additional bonus for increasing the basket size be provided. Expected value may be defined by an expectation level of a particular action to work for the user. In other words, how much value a selected driving action may produce. By way of example and not limitation, expected value may be determined based on the quality and/or confidence of a product recommendation, the size of a bonus or reward offer, and other such factors that may increase the chances of a user purchasing or otherwise selecting a product/service associated with a driving action. Context operates as a filter, providing contextually relevant driving actions, and expected value of the driving actions may be used as a ranking. Selecting a driving action may include selecting one or more driving actions that have a high ranking (i.e., expected value) and which fits the current context. In some instances, no driving actions may be selected.

In some instances, publishers can define driving actions. For instance, a publisher may provide one or more driving actions to the service. The publisher may also provide the service with criteria for when the driving actions should be provided. In this regard, the service server 201 may select a driving action provided by the publisher upon the criteria being met. For instance, a publisher may instruct the service server 201 to provide a rebate to a user viewing a competitor's webpage to attract the user to the publisher's webpages.

Referring to block 311, the service server 201 may determine recipients to notify that an activity type has been successfully classified. In this regard, parties with an interest in a particular activity type may have an agreement with the service for notifications for particular activity type classifications. For instance, the service server 201 may determine that an activity type has been successfully classified for activity occurring on a customized browser, such as browser 206, which is embedded in a publisher's application, such as publisher app 204. Based on this determination, the service server 201 may notify the publisher. Notification to the publisher may include a webhook, an alert, or other such notification that is sent from the service server 201 to the publisher server 203, as shown in block 225 of FIG. 2. Based on the notification received from the service server 201, the publisher server 203 may initiate an action within the publisher app 204 or browser 206. For example, the publisher server 203 may provide an advertisement within the publisher's application 204 or customized browser 206 based on the classified activity type, the enriched the data associated with the requested URL, user data, and/or any other information that may be provided by the service server 201 to the publisher server 203.

Referring again to FIG. 3, the service server 201 may respond to the customized browser's request for an activity type classification of the requested URL, as shown in block 313. The response may include enriched data, selected driving actions, the activity type classification, and/or any other data and instructions retrieved, determined, and/or received by the service server 201 as outlined with reference to blocks 301-311. Collectively the data and instructions returned in the response may be referred to as classification returns. The classification returns may be in the form of structured data, scripts, instructions, etc. that may be loaded by the customized web browser 206.

The customized browser may be configured in accordance with the received classification returns, as shown in block 227 of FIG. 2. For example, the customized browser 206 may execute some or all of the instructions received in the classification returns, display data received in the classification returns. In some instances, the customized browser 206 may be programmed to take particular actions upon receiving particular classification returns. For instance, the publisher may program the customized browser to display an ad, coupon, rebate, product recommendation, price comparison, user review, etc., in response to the classification returns indicating a particular classification type. In another example, the customized browser 206 may notify the publisher application 204 in which it is embedded that a particular activity classification was received in the classification returns, as shown in block 231. The publisher application may receive this information, as shown in block 233, and may take some action in response.

As shown in block 229, the customized browser may load the web page associated with the requested URL. Although FIG. 2 illustrates the customized browser 206 loading the web page associated with the requested URL after blocks 221-227, the customized browser 206 may load the web page associated with the requested URL in parallel with the execution of the steps outlined with respect to blocks 221-227.

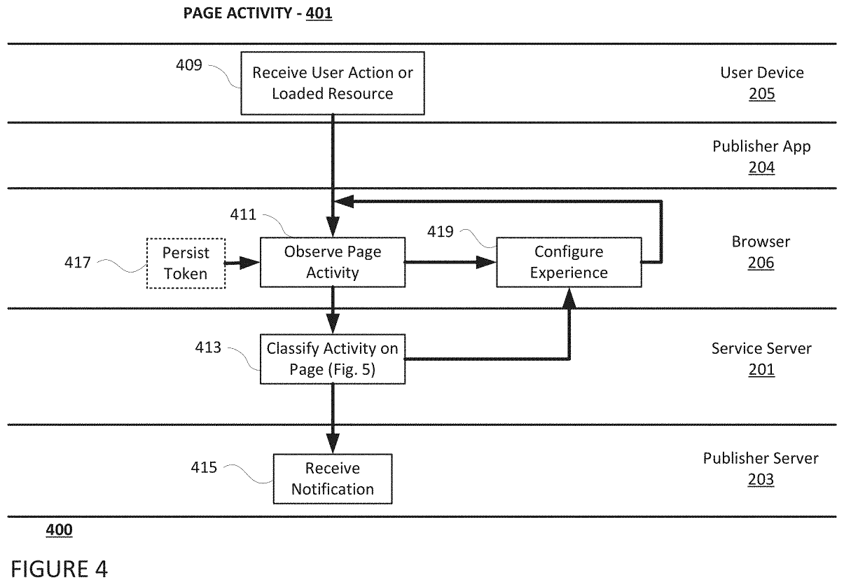

Part three 401, showing the operations of conducting activity within a page on the customized browser 206, is shown in flow diagram 400 of FIG. 4. As shown in block 417, the token provided created and provided by the service server 201 may continue to be persisted throughout part three 401.

After completion of blocks 229, and if necessary blocks 231 and 233 shown in FIG. 2, the customized browser may monitor and collect activity that occurs on a loaded webpage. In this regard, the customized browser may monitor and collect activity on a web page as shown in block 411 of FIG. 4. Such activity may be received as the result of a user action or resources loaded by the user device 205, as shown in block 409. Other activity may the result of data and instructions loaded within a web page. For example, activity that that may be monitored on a web page loaded on the customized browser 206 may include resource loading on a web page (e.g. pixels), the operation of scripts that may be injected into the web page to observe dynamic page changes, user activity on the page (e.g. add to cart, view an item, purchase an item, etc.), and other such activity. Some or all activity on a page may be sent to the service server 201 for classification as shown in block 413.

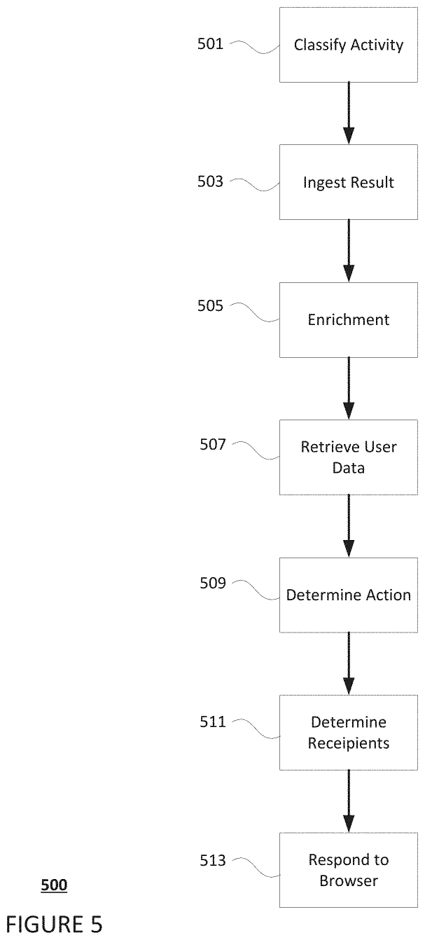

The classification of activity on a page may be similar to that of the classification of an activity based on a requested URL as described with regard to FIGS. 2 and 3 herein. In this regard, and as illustrated in flow diagram 500 of FIG. 5, the service server 201 may receive the monitored activity for classification, as shown in block 501. Classification of the activity on the web page may be performed using the same techniques described herein with regard to classifying requested URLs, as described in reference to at least block 301 of FIG. 3. In this regard, the activity models may be trained using training data associated with observed user shopping sessions. For instance, user shopping sessions may be tracked and each activity occurring within a session may be tagged. This data, including some or all of the URLs associated with the webpages, activity on the webpages, etc., may be used to generate an activity model to automatically classify activity on a webpage. Incoming activity data may then be classified using the trained activity model resulting in the activity being classified (or not) into an activity type.

Upon classifying the activity type, the service server 201 may ingest results as shown in block 503, enrich data as shown in block 509, determine recipients as shown in block 511, and respond to the customized web browser as shown in block 513. Each of these steps may be performed by the service server 201 as explained above with regard to steps 303-313 of FIG. 3.

Referring to block 415, the service server 201 may determine recipients to notify that an activity type has been successfully classified. Based on this determination, the service server 201 may notify the publisher. Notification to the publisher may include a webhook, an alert, or other such notification that is sent from the service server 201 to the publisher server 203, as explained with regard to block 225 of FIG. 2.

Referring to block 419, the customized browser 206 may be configured in accordance with the received classification returns received in the response from the service server 201. Customization may be similar to that described with regard to block 227 of FIG. 2. Flow diagrams 200 and 400 are for illustration purposes only. The order of the steps shown in the blocks may be non-linear. For instance, a user may requests a new URL after or during the operation of part three.

Although the foregoing examples describe certain steps as being performed by the service server 201, these steps may alternatively performed by the customized browser 206. For instance, the customized browser may be programmed to perform the activity classifications described in regard to FIGS. 3 and 5. Further, the features of the customized browser and/or service server may be performed by extensions. Moreover, some function of the customized web browser may be performed by the service server.

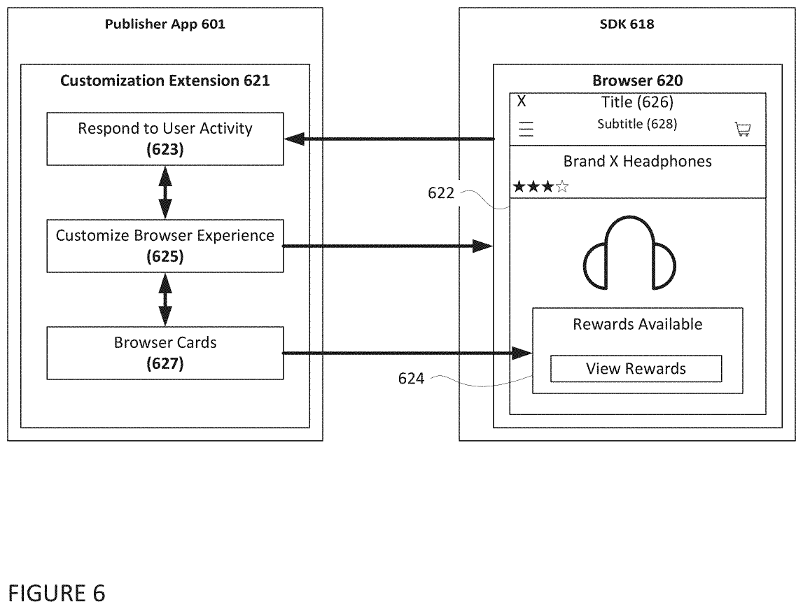

FIG. 6 illustrates an example customization extension 621 through which a publisher may leverage the features of the customized browser without the need to embed the customized web browser in their application 601. Customizations, shown by block 625, may include, by way of non-limiting example, setting the title 626 of the displayed destination 622, setting a subtitle 628 of the displayed destination 622, set the color scheme of the browser, provide actions if certain locations of the browser, such as the title 626 or subtitle 628, are selected.

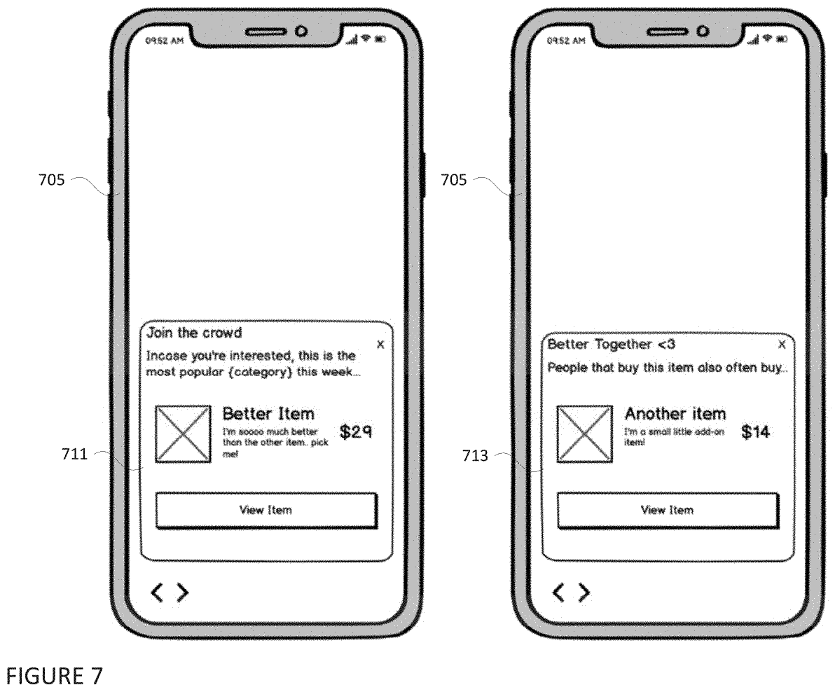

As a user navigates through web pages in the publisher app 601, the customization extension 621 may track the navigation and activity within web browser, as shown by the respond to user activity block 623. In this regard, the customization extension 621 may provide a communication interface with the service server 201 classify activity associated with a requested URL or activity on a web page, as outlined in flow diagrams 3 and 5, respectively. Content returns may be received by the customization extension 621 which may trigger browser cards 627 to be displayed on the display of a user device, as shown by reward card 624. In this regard, the customization extension 621 may also provide the ability to overlay cards or other such notifications objects within the browser 620. For instance and as further shown in FIG. 6, the customization extension 621 may overlay a “reward” card 624 on the display. The card 624 may inform the user of the user device that rewards are available for the product being displayed in the web browser or that other rewards, such as rewards associated with the publisher are available to the user. The customization extension 621 may also provide the ability to remove, hide, or scroll through cards within the customized web browser. FIG. 7 illustrates example cards 711, 713 that may be generated on a user device 705 based on classification returns, as described herein.

The technology described above may be used to enable commissioning. In this regard, based on the activity type classifications of URLs and activities, the service may be notified of purchase activities. Based on these notifications and knowledge of the web locations a user has visited, the publisher app the user is in, and other such data, the service may determine whether any commissions are due and to whom. For instance, when a driving action leads to a purchase, as indicated by an activity type “purchase made” being classified based on a user's activity, the service may determine a commission is owed by the retailer from which the good was purchase and/or the publisher. The token may enable both retailers and the service to track commissioned purchases.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for supplementing information received from a uniform resource locator (URL), the method comprising:
receiving, by one or more processors, a requested URL;
inputting, by the one or more processors, data within the requested URL into a machine learning model;
receiving, by the one or more processors and from the machine learning model, a classified activity type for the requested URL, wherein the classified activity type is determined based on the data within the requested URL and the classified activity type is indicative of one or more shopping stages that occurs on a webpage accessible with the requested URL;
retrieving, by the one or more processors, additional information associated with the requested URL based on the classified activity type;
determining, by the one or more computers, one or more driving actions based on the classified activity type and the additional information, each of the one or more driving actions configured to cause a web browser to perform an action; and
providing, by the one or more processors, the one or more driving actions, the classified activity type, and the additional information to the web browser.

2. The method of claim 1, wherein a requested URL is received from the web browser, the web browser executing on a remote user device.

3. (canceled)

4. (canceled)

5. The method of claim 1, wherein the additional information includes user data associated with a user of the browser; product reviews for a product on a webpage of the requested URL, confirmation that a checkout was completed based on the context of the webpage of the requested URL, an indication that the webpage of the requested URL is a checkout page; an indication that a product was added to a cart of an online retailer associated with the requested URL, and/or information that a product is on the requested URL.

6. The method of claim 1, wherein determining the one or more driving actions further includes:
selecting one or more predefined driving actions based on context including user data and the classified activity type;
ranking the selected predefined driving actions; and
selecting one or more of the highest ranked predefined driving actions as the one or more driving actions to provide to the web browser.

7. The method of claim 1 further comprising:
providing a token to the web browser, the token identifying a user or user account of the web browser.

8. A service system for supplementing information received from a uniform resource locator (URL), the system comprising:
one or more processors; and
one or more storage devices in communication with the one or more processors, wherein the one or more storage devices contain instructions configured to cause the one or more processors to:
receive a requested URL;
input data within the requested URL into a machine learning model;
receive, from the machine learning model, a classified activity type for the requested URL, wherein the classified activity type is determined based on the data within the requested URL and the classified activity type is indicative of one or more shopping stages that occurs on a webpage accessible with the requested URL;
retrieve additional information associated with the requested URL based on the classified activity type;
determine one or more driving actions based on the classified activity type and the additional information, each of the one or more driving actions configured to cause a web browser to perform an action; and
provide the one or more driving actions, the classified activity type, and the additional information to the web browser.

9. The system of claim 8, wherein a requested URL is received from the web browser, the web browser executing on a remote user device.

10. (canceled)

11. (canceled)

12. The system of claim 8, wherein the additional information includes user data associated with a user of the browser; product reviews for a product on a webpage of the requested URL, confirmation that a checkout was completed based on the context of the webpage of the requested URL, an indication that the webpage of the requested URL is a checkout page; an indication that a product was added to a cart of an online retailer associated with the requested URL, and/or information that a product is on the requested URL.

13. The system of claim 8, wherein determining the one or more driving actions further includes:
selecting one or more predefined driving actions based on context including user data and the classified activity type;
ranking the selected predefined driving actions; and
selecting one or more of the highest ranked predefined driving actions as the one or more driving actions to provide to the web browser.

14. The system of claim 8, wherein the instructions are further configured to cause the one or more processors to:
provide a token to the web browser, the token identifying a user or user account of the web browser.

15. A non-transitory computer readable medium containing instructions, which when executed by one or more processors, cause the one or more processors to:
receive a requested URL;
input data within the requested URL into a machine learning model;
receive, from the machine learning model, a classified activity type for the requested URL, wherein the classified activity type is determined based on the data within the requested URL and the classified activity type is indicative of one or more shopping stages that occurs on a webpage accessible with the requested URL;
retrieve additional information associated with the requested URL based on the classified activity type;
determine one or more driving actions based on the classified activity type and the additional information, each of the one or more driving actions configured to cause a web browser to perform an action; and
provide the one or more driving actions, the classified activity type, and the additional information to the web browser.

16. The non-transitory computer readable medium of claim 15, wherein a requested URL is received from the web browser, the web browser executing on the remote user device.

17. (canceled)

18. (canceled)

19. The non-transitory computer readable medium of claim 15, wherein the additional information includes user data associated with a user of the browser; product reviews for a product on a webpage of the requested URL, confirmation that a checkout was completed based on the context of the webpage of the requested URL, an indication that the webpage of the requested URL is a checkout page; an indication that a product was added to a cart of an online retailer associated with the requested URL, and/or information that a product is on the requested URL.

20. The non-transitory computer readable medium of claim 15, wherein determining the one or more driving actions further includes:
selecting one or more predefined driving actions based on context including user data and the classified activity type;
ranking the selected predefined driving actions; and
selecting one or more of the highest ranked predefined driving actions as the one or more driving actions to provide to the web browser.

21. The method of claim 1, wherein the classified activity type is further identified by the type of activity represented by a resource accessible with the requested URL.

22. The system of claim 8, wherein the classified activity type is further identified by the type of activity represented by a resource accessible with the requested URL.

23. The non-transitory computer readable medium of claim 15, wherein the classified activity type is further identified by the type of activity represented by a resource accessible with the requested URL.
